(19) United States
(12) Patent Application Publication
(10) Pub. No.: US 2015/0016725 A1
(43) Pub. Date: Jan. 15, 2015

(54) RETRIEVAL METHOD AND ELECTRONIC APPARATUS

(71) Applicant: KABUSHIKI KAISHA TOSHIBA, Tokyo (JP)

(72) Inventor: Hideki Tsutsui, Kawasaki-shi (JP)

(73) Assignee: KABUSHIKI KAISHA TOSHIBA, Tokyo (JP)

(21) Appl. No.: 14/252,678

(22) Filed: Apr. 14, 2014

Related U.S. Application Data
(63) Continuation of application No. PCT/JP2013/068741, filed on Jul. 9, 2013.

(51) Int. Cl. G06K 9/18

(52) U.S. Cl. CPC G06K 9/18
USPC 382/187

(57) ABSTRACT

According to one embodiment, a retrieval method includes receiving a first stroke corresponding to a retrieval key for retrieving a handwritten stroke stored in a memory of an electronic apparatus; acquiring, if the first stroke comprises a second stroke for filling an area and a third stroke not for filling an area, first information relating to at least one stroke corresponding to the retrieval key by using the third stroke, wherein the second stroke corresponds to one part of the first stroke, and the third stroke corresponds to another part of the first stroke; and storing the first information in the memory.

### CROSS-REFERENCE TO RELATED APPLICATIONS

This application is a Continuation Application of PCT Application No. PCT/JP2013/068741, filed Jul. 9, 2013, the entire contents of which are incorporated herein by reference.

### FIELD

Embodiments described herein relate generally to a technique of processing a handwritten input.

### BACKGROUND

In recent years, various electronic apparatuses such as a tablet computer, PDA, and smartphone have been developed. In most cases, such electronic apparatus includes a touch screen display to ease an input operation by a user.

A user touches a menu or object displayed on the touch screen display by his finger or the like to instruct the electronic apparatus to execute a function associated with the menu or object. Furthermore, the user handwrites a letter, figure, and diagram with his finger or stylus on the touch screen display to cerate a handwriting including a plurality of strokes.

To smoothly retrieve a handwriting including a certain required character string or the like from a plurality of handwritings, a handwriting retrieval function is necessary. However, a technique to retrieve a desired handwriting with enough efficiency has not been developed yet.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates an example of an exterior of an electronic apparatus of an embodiment.

FIG. 2 illustrates an example of a cooperative work of the electronic apparatus of the embodiment with an external device.

FIG. 3 illustrates an example of a handwriting handwritten on a touch screen display of the embodiment.

FIG. 4 illustrates an example of time series information of the embodiment.

FIG. 5 illustrates an example of a block diagram of a system structure of the electronic apparatus of the embodiment.

FIG. 6 illustrates an example of a block diagram of a function of a handwritten input application program executed by the electronic apparatus of the embodiment.

FIG. 7 illustrates a flowchart of an example of a procedure to prepare the handwriting of the embodiment.

FIG. 8 illustrates a flowchart of an example of fill determination process of the embodiment.

FIG. 9 illustrates an example of a stroke of the embodiment.

FIG. 10 illustrates an example of another stroke of the embodiment.

FIG. 11 illustrates an example of another stroke of the embodiment.

FIG. 12 illustrates an example of a figure filled by a plurality of strokes of the embodiment.

FIG. 13 illustrates an example of a figure filled by the handwriting of the embodiment.

FIG. 14 illustrates a flowchart of a first retrieval process of the embodiment.

FIG. 15 illustrates an example of a handwriting retrieval screen of the embodiment.

FIG. 16 illustrates an example of an input of a query stroke of the embodiment.

FIG. 17 illustrates another example of the handwriting retrieval screen of the embodiment.

FIG. 18 illustrates a flowchart of a second retrieval process of the embodiment.

FIG. 19 illustrates contents of a figure retrieval process of the embodiment.

FIG. 20 illustrates how a handwritten input of the stroke is made in the embodiment.

FIG. 21 illustrates a relationship between the number of sample points and sample point density of the handwritten stroke of the embodiment.

FIG. 22 illustrates the stroke divided in the embodiment.

FIG. 23 illustrates an example of a surface stroke of the embodiment.

FIG. 24 illustrates another example of the surface stroke of the embodiment.

### DETAILED DESCRIPTION

Various embodiments will be described hereinafter with reference to the accompanying drawings.

In general, according to one embodiment, according to one embodiment, a retrieval method includes receiving a first stroke corresponding to a retrieval key for retrieving a handwritten stroke stored in a memory of an electronic apparatus; acquiring, if the first stroke comprises a second stroke for filling an area and a third stroke not for filling an area, first information relating to at least one stroke corresponding to the retrieval key by using the third stroke, wherein the second stroke corresponds to one part of the first stroke, and the third stroke corresponds to another part of the first stroke; and storing the first information in the memory.

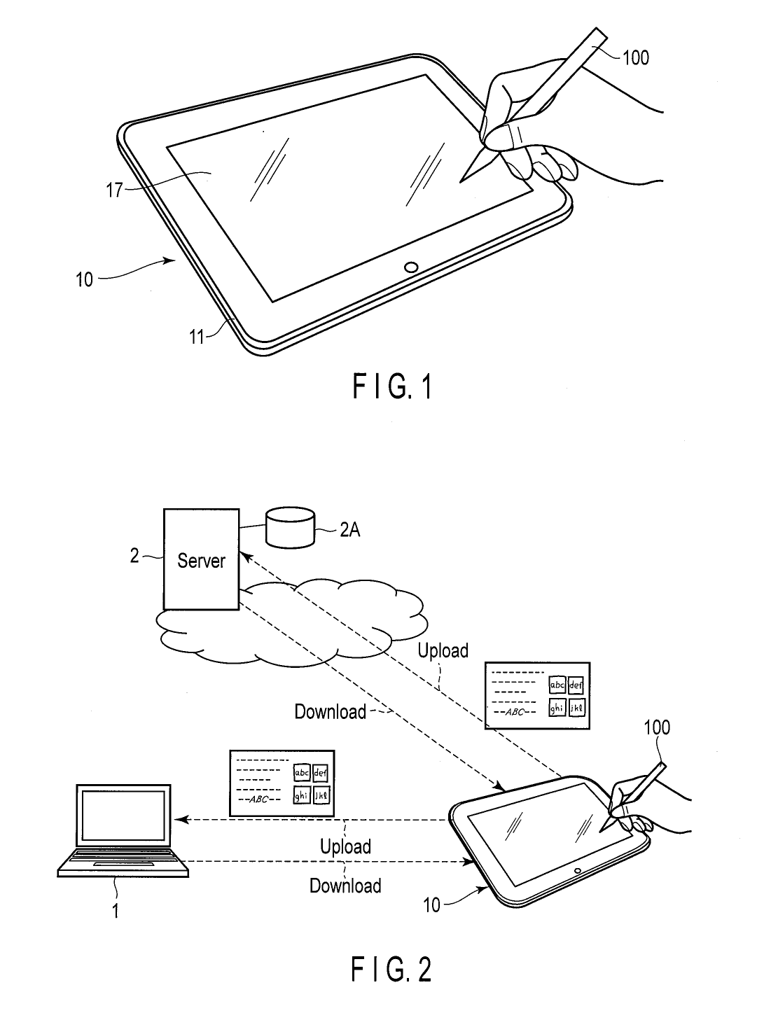

FIG. 1 is a perspective view of an exterior of an electronic apparatus of the embodiment. The electronic apparatus is, for example, a portable electronic apparatus which can accept a handwritten input made by a stylus or finger. Such an electronic apparatus may be materialized as a tablet computer, notebook personal computer, smartphone, personal digital assistant (PDA), and the like. Hereinafter, the description is presented given that the electronic apparatus is materialized as a tablet computer 10. The tablet computer 10 is a portable electronic apparatus which is often referred to as a tablet or slate computer, and as shown in FIG. 1, includes a main body 11 and touch screen display 17. The main body 11 includes a thin box-shaped casing. The touch screen display 17 is attached to an upper surface of the main body 17 overlapping therewith.

In the touch screen display 17, a flat panel display and a sensor configured to detect a point of contact of a stylus or finger on the flat panel display are integrated. The flat panel display may be, for example, a liquid-crystal display device (LCD). The sensor may be, for example, an electrostatic capacitance touchpanel or electromagnetic induction digitizer. The following description is presented given that both digitizer and touchpanel are integrated in the touch screen display 17 as sensors.

The digitizer is located at the lower side of the screen of the flat panel display. The touchpanel is located on the screen of the flat panel display. The touch screen display 17 may detect not only a touch operation on the screen with a user's finger but also a touch operation on the screen with a stylus 100. The stylus 100 may be, for example, an electromagnetic induction stylus. A user uses an external object (stylus 100 or finger) to perform a handwriting input operation on the touch screen display 17. During the handwriting input operation, a motion trail of the external object (stylus 100 or finger) moving on the screen, that is, a trail of stroke (handwriting) handwritten by the handwriting input operation is depicted in real time, and each trail of stroke is displayed on the screen. The motion trail of the external object between a time of touching and a time of leaving the screen is counted as a single stroke. A set of multiple strokes corresponding to a handwritten letter or figure, that is, a set of multiple trails (handwritings) structures a handwriting.

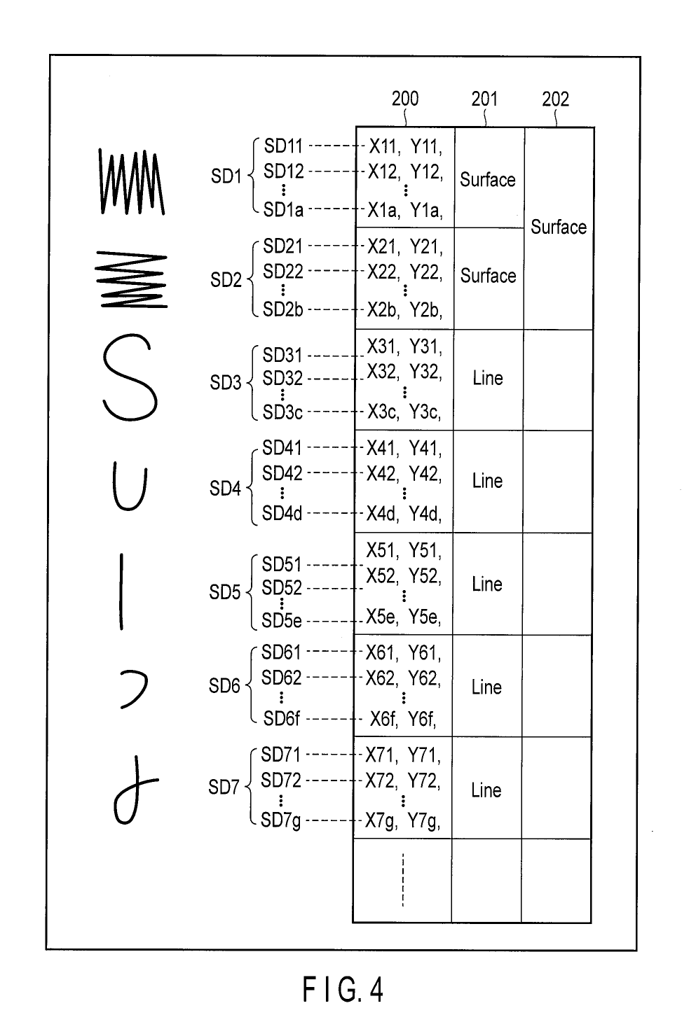

In the present embodiments, the handwriting is stored in a storage medium as time series information indicative of coordinate data row of each trail of stroke and a sequential relationship between strokes, not as an image data. The time series information is described below in detail with reference to FIG. 4. The time series information indicates a sequence of handwriting of a plurality of strokes and a plurality of stroke data corresponding to each of the plurality of strokes. In other words, the time series information stands for a set of time series stroke data corresponding to each of the plurality of strokes. Each stroke data corresponds to a certain stroke and includes the coordinate data series (time series coordinates) corresponding to each point on the trail of stroke. The sequence of the plurality of stroke data corresponds to a sequence of handwriting of each stroke, that is, a stroke order.

The tablet computer 10 reads out any optional time series information (handwriting) from the storage medium and displays the handwriting corresponding to the time series information, that is, trails corresponding to each of the strokes indicated based on the time series information on the screen. Furthermore, the tablet computer 10 includes an edit function. With the edit function, the user can perform an edit operation using an “eraser” tool, range selecting tool, and various other tools to erase or remove any optional stroke or handwritten letter in the handwriting currently being displayed. The edit function includes a function to cancel a history of some handwriting operations previously made.

Furthermore, the tablet computer 10 includes a handwriting retrieval (stroke retrieval) function. The handwriting retrieval may be performed under any scheme as long as it uses one or more handwritten strokes (query stroke) as a retrieval key (query stroke) and retrieves one or more strokes corresponding to the query stroke from any optional handwriting. The handwriting retrieval may be performed to retrieve a handwriting including one or more strokes corresponding to one or more query strokes from the storage medium. Here, the one or more strokes corresponding to one or more query strokes may be one or more strokes similar to one or more query strokes. In the handwriting retrieval, by performing, for example, matching a query stroke with each of a plurality of strokes (stroke matching), one or more strokes having a feature amount which is similar to that of the query stroke is retrieved from a handwriting. When a plurality of strokes are input as a retrieval key (query stroke) by handwriting, the aforementioned stroke matching is performed per stroke in a query stroke group.

As a feature amount of a certain stroke, any optional feature representing a handwriting feature of the certain stroke may be used. For example, a feature amount data representing a shape, writing direction, and slant of the stroke may be used.

The handwriting retrieval function enables the user to easily find a desired handwriting from the many handwritings created by the user previously and to easily find a desired handwriting part from a handwriting. The handwriting retrieval can retrieve not only a handwritten character but also a handwritten figure, mark, or the like.

In the present embodiment, the aforementioned time series information (handwriting) may be managed as a single page or a plurality of pages. Here, the time series information (handwriting) may be divided into several items by an area unit to fit in a single screen, and a group of the items of the time series information fit in the single screen may be stored as a single page. Or, a size of the page may be set variable. When the size is variable, it is expanded to have an area larger than the size of a single screen, and thus, a handwriting having an area larger than the screen size can be handled as a single page. When the whole page cannot be displayed in a single frame at the same time, the page may be reduced to include the whole page or a displayed part of the page may be moved by vertical and horizontal scrolls.

FIG. 2 illustrates an example of how the tablet computer 10 works in cooperation with external devices. The tablet computer can cooperate with a personal computer 1 and cloud computing system. That is, the tablet computer 10 includes a wireless communication device such as a wireless LAN and executes wireless communication with the personal computer 1. Furthermore, the tablet computer 10 may execute communication with a server 2 on the Internet. The server 2 may be a server configured to execute an online storage service or various cloud computing services.

The personal computer 1 includes a storage device such as a hard disk drive (HDD). The tablet computer 10 transmits (uploads) the time series information (handwriting) to the personal computer 1 via a network to store the time series information (handwriting) in the HDD of the personal computer 1. To secure the communication between the tablet computer 10 and personal computer 1, the personal computer 1 may authorize the tablet computer 10 when initializing the communication. Here, a dialog box may be displayed on a screen of the tablet computer 10 to prompt the user to input an ID or password, or the ID of the tablet computer 10 may be transferred to the personal computer 1 automatically from the tablet computer 10.

Thereby, even when the storage volume inside the tablet computer 10 is low, the tablet computer 10 can handle a large number of the items of the time series information (handwriting) or a large volume of the time series information (handwriting).

Furthermore, the tablet computer 10 reads out (downloads) any optional one or more handwritings stored in the HDD of the personal computer 1, and displays each trail of the strokes depicted by the read-out handwriting on a screen of the display 17 of the tablet computer 10. Here, a list of thumbnails of downsized pages of the handwritings may be displayed on the screen of the display 17, or a single page selected from the thumbnails may be displayed on the screen of the display 17 in a normal size.

Furthermore, as mentioned above, the tablet computer 10 may communicate with the server 2 on the cloud computing system which provides the storage service instead of the personal computer 1. The tablet computer 10 transmits (uploads) the handwriting to the server 2 over the network to record the handwriting in a storage device 2A of the server 2. Furthermore, the tablet computer 10 reads out (downloads) any optional handwriting stored in the storage device 2A of the server 2, and displays each trail of the strokes depicted by the read-out handwriting on the screen of the display 17 of the tablet computer 10.

As can be understood from the above, in the present embodiments, the storage medium configured to store the handwriting may be a storage device in the tablet computer 10, a storage device in the personal computer 1, or a storage device of the server 2.

Furthermore, the system which can execute the aforementioned handwriting retrieval in the present embodiment may be a local system achieved in the tablet computer 10, or may be a system (server system) including one or more servers. Here, the tablet computer 10 may function as a client terminal which operates both process of transmitting a group of query strokes to the server system and process of displaying a retrieval result on the screen of the tablet computer 10 received from the server system.

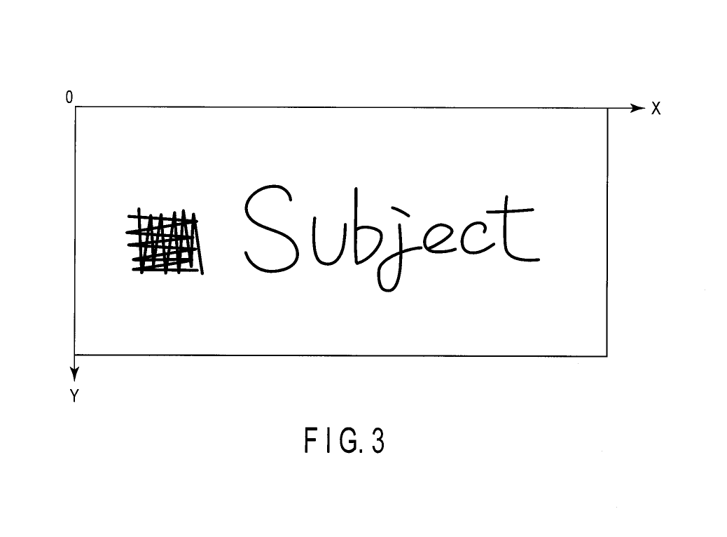

Now, a relationship between the strokes (letter, mark, figure, diagram, etc.) handwritten by the user and the handwriting is described with reference to FIGS. 3 and 4. FIG. 3 illustrates an example of strokes handwritten on the touch screen display 17 by the stylus 100.

FIG. 3 illustrates the handwritten strokes representing a filled-in figure (hereinafter occasionally referred to as a fill) and the handwritten strokes representing a character string of “Subject”. The filling-in shown in FIG. 3 includes a vertical zigzag stroke and a lateral zigzag stroke one layered on another, for example. A substantially quadrilateral black figure is represented by the two overlapping strokes.

The strokes in the fill or the strokes representing the letter are sampled in real time at regular time intervals to obtain time series coordinate data. For example, from the stroke input firstly, the time series coordinate data SD11, SD12, . . . and SD1a are obtained, and from the stroke input next, the time series coordinate data SD21, SD22, . . . and SD2b are obtained.

FIG. 4 illustrates time series information 200 corresponding to handwritten stroke strings of FIG. 3. The time series information 200 includes a plurality of stroke data SD1, SD2, . . . and SD7. In the time series information 200, the stroke data SD1, SD2, . . . and SD7 are arranged in the stroke order, that is, in a chronological order of handwriting of the strokes.

Each stroke data includes a coordinate data series (time series coordinates) corresponding to a single stroke, that is, a plurality of coordinate data corresponding to a plurality of points on a single stroke. In each stroke data, the coordinate data are arranged in a chronological order of handwriting of the stroke. For example, in FIG. 4, the stroke data SD1 corresponds to the initial stroke of the fill and includes the coordinate data series (time series coordinates) corresponding to the points on the single stroke, that is, “a” items of the coordinate data SD 11, SD12, . . . and SD1a. The stroke data SD2 corresponds to the next stroke and includes, similarly, “b” items of the coordinate data SD21, SD22, . . . and SD2b. The stroke data SD3 corresponds to the handwritten letter “S” and includes “c” items of the coordinates data SD31, SD32, . . . and SD3c. Note that the number of coordinates data corresponding to a single stroke varies depending on a time taken for writing the stroke since the sampling is performed in real time at regular time intervals. That is, the number of coordinate data increases when the time taken for writing the stroke becomes longer.

The coordinate data in the stroke data represents the X and Y coordinates corresponding to a single point on the trail of the stroke. For example, the coordinate data SD11 represents the start coordinates (X11, Y11) of the initial stroke while the coordinate data SD1a represents the end coordinates (X1a, Y1a) of the initial stroke.

Since the handwriting is stored as a set of the time series stroke data instead of an image or a result of character recognition, the handwritten letter can be handled without depending on a language of the handwritten letter. Therefore, the handwriting (time series information 200) structure of the present embodiment can be used commonly in various countries where different languages are used.

Furthermore, a label 201 is added to each of the stroke data in the time series information 200 to indicate whether or not the stroke is in a fill. Whether or not the stroke is in a fill is determined based on the fill determination process described below. After the fill determination process, a label “surface” indicative of a surface stroke is added to the stroke which has been determined to be in a fill while a label “line” indicative of a linear stroke is added to the stroke which has not been determined to be in a fill.

When a single fill is represented by a plurality of strokes, the label added to each stroke may be merged together to add a label corresponding to the strokes. For example, FIG. 4 shows that a merged label 202 (label “surface”) is added to the two strokes representing the fill.

Among the strokes to be merged together, as the strokes SD1 and SD2 in FIG. 4, at least one of them is a surface stroke, and a part of the coordinate data included in each stroke data overlaps with each other. Here, the label “surface” may be added by merging three or more strokes or by merging the surface stroke and linear stroke together.

Furthermore, what to be merged are not only the strokes whose coordinate data overlap with each other but also the strokes whose coordinate data are close with each other. For example, when a filled-in figure (e.g. a black quadrilateral) is written, sometimes the outline of the figure is written first and the inside of the figure is filled in later. In such a case, the filled-in figure is comprised of the strokes representing the outline and the strokes corresponding to the fill, and thus, both strokes representing outline and fill are merged together to be labeled as “surface”. Note that strokes are judged close when, for example, the coordinate data of two strokes are within a certain range (including a case where they coincide) and the number of the coordinate data within a certain range is more than a predetermined value.

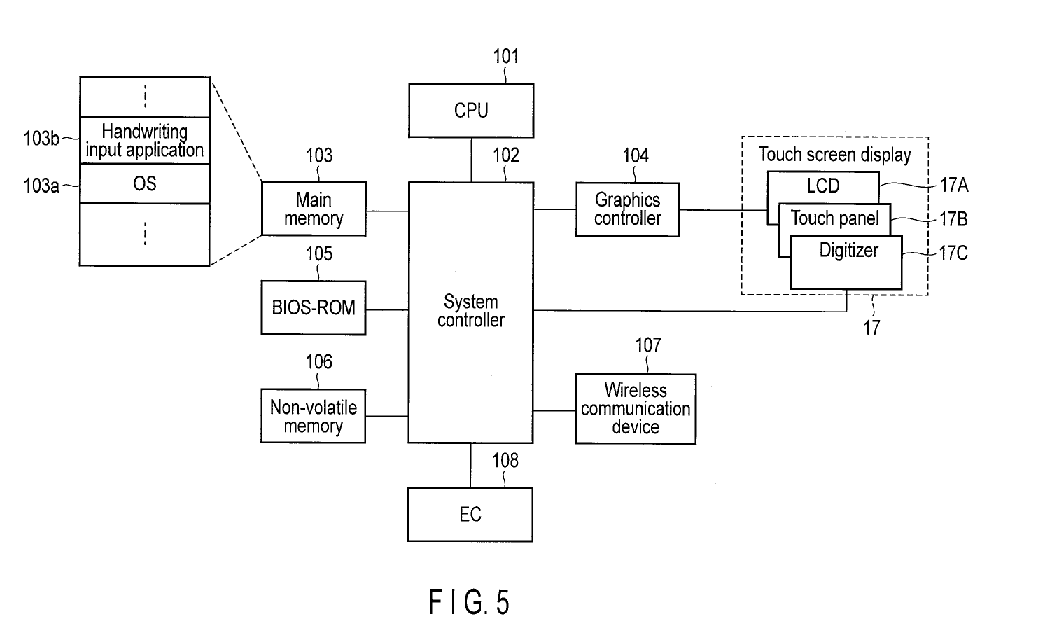

FIG. 5 illustrates a system structure of the tablet computer 10.

As shown in FIG. 5, the tablet computer 10 includes a CPU 101, system controller 102, main memory 103, graphics controller 104, BIOS-ROM 105, non-volatile memory 106, wireless communication device 107, and embedded controller (EC) 108.

The CPU 101 is a processor configured to control actions of each module in the tablet computer 10. The CPU 101 executes various software programs loaded from the non-volatile memory 106, which is a storage device, to the main memory 103. The software programs include an operating system (OS) 103a and various application programs. The application programs include a handwriting input application program 103b. The handwriting input application program 103b includes the aforementioned handwriting preparation and display function, handwriting edit function, handwriting retrieval function, and recognition function, etc.

The CPU 101 executes a basic input output system stored in the BIOS-ROM 105. The BIOS is a program for hardware control.

The system controller 102 is a device to connect a local bus to various components. The system controller 102 includes a built-in memory controller configured to control access of the main memory 103. Furthermore, the system controller 102 includes a function to execute a communication with the graphic controller 104 via a serial bus.

The graphic controller 104 is a display controller configured to control an LCD 17A which is used as a display monitor of the tablet computer 10. A display signal generated by the graphic controller 104 is transmitted to the LCD 17A. The LCD 17A displays a screen image based on the display signal. A touch panel 17B and digitizer 17C are provided on the LCD 17A. The touch panel 17B is a capacitive pointing device used for an input on the screen of the LCD 17A. When a finger contacts the screen, a point of contact thereof and movement of the point of contact are detected by the touch panel 17B. The digitizer 17C is an electromagnetic induction pointing device used for an input on the screen of the LCD 17A. When a stylus 100 contacts the screen, a point of contact thereof and movement of the point of contact are detected by the digitizer 17C.

The wireless communication device 107 is configured to execute wireless communication such as a wireless LAN and 3G mobile communication. The EC 108 is a one-chip computer including an embedded controller for power management. The EC 108 is configured to turn on/off the power of the tablet computer 11 in response to a power button operation by the user.

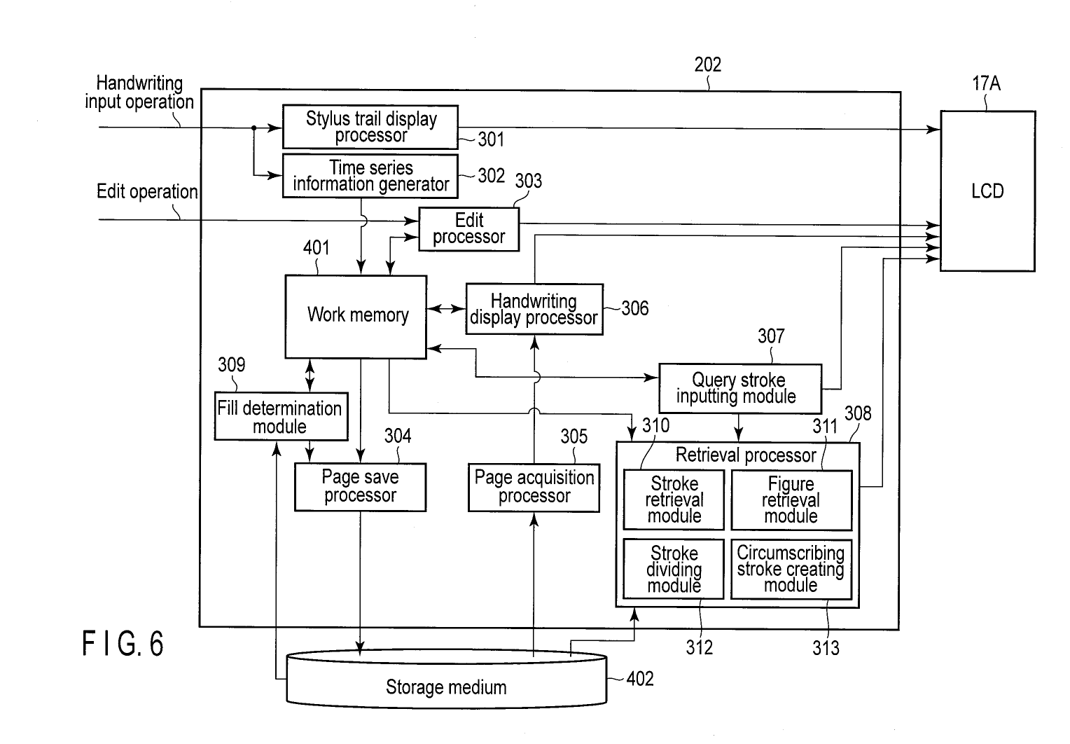

Now, the handwriting input application program 103b is described with reference to FIG. 6.

The handwriting input application program 103b includes functions such as a stylus trail display processor 301, time series information generator 302, edit processor 303, page save processor 304, page acquisition processor 305, handwriting display processor 306, query stroke inputting module 307, retrieval processor 308, and fill determination module 309.

The handwriting input application program 103b performs preparation, display, and edit, etc. of handwriting (handwriting data) by using the stroke data input by the touch screen display 17. The touch screen display 17 is configured to detect events such as “touch”, “move (slide)”, and “release” occurring thereon. The event “touch” indicates that an external object has touched the screen. The event “move (slide)” indicates that a point of contact has moved on the screen while the external object is touching thereon. The event “release” indicates that the external object has left the screen.

The stylus trail display processor 301 and time series information generator 302 receive the event of “touch” or “move (slide)” generated on the touch screen display 17 to detect the handwriting input operation. The event “touch” includes the coordinate data of the point of contact. In addition, the event “move (slide)” includes the coordinate data of the point of contact after the move. Thus, the stylus trail display processor 301 and time series information generator 302 receive a coordinate data row corresponding to the trail of the movement of the point of contact from the touch screen display 17.

The stylus trail display processor 301 receives the coordinate data row from the touch screen display 17, and based on the coordinate data row, displays trails of the strokes input by the handwriting input operation using the stylus 100 or the like on the screen of the LCD 17A of the touch screen display 17. By the stylus trail display processor 301, the trail of the stylus 100 during the contact on the screen, that is, the trail of each stroke is depicted on the screen of the LCD 17A.

The time series information generator 302 receives the coordinate data row output from the touch screen display 17 when the user performs the handwriting input operation, and based on the coordinate data row, generates the stroke data (time series information). The stroke data (time series information) may be stored in a work memory 401 temporarily.

The page save processor 304 stores a plurality of stroke data corresponding to a plurality of strokes in a storage medium 402. As mentioned above, the storage medium 402 may be a storage device in the tablet computer 10, a storage device in the personal computer 1, or a storage device of the server 2.

The page acquisition processor 305 reads out the handwriting stored in the storage medium 402. The read-out handwriting is transmitted to the handwriting display processor 306. The handwriting display processor 306 analyzes the handwriting, and based on a result of the analysis, displays on the screen the strokes (trails) represented by the stroke data in the handwriting as a handwritten page.

The edit processor 303 executes a process to edit a handwriting (handwritten page) currently being displayed. That is, based on edit operations performed by the user on the touch screen display 17, the edit processor 303 executes an edit process to erase or remove one or more strokes in the displayed strokes. Furthermore, the edit processor 303 updates the handwriting to reflect a result of the edit process thereon.

The user uses a tool such as an “eraser” to erase any optional stroke in the displayed strokes. Furthermore, the user uses a tool such as a “range select” to circle or box in any optional portion of the displayed handwritten page for select a range of any optional portion in the handwritten page.

The fill determination module 309 executes a fill determination process with respect to the stroke data (time series information) generated by the time series information generator 302, and determines whether or not the strokes represent a fill (surface stroke). Based on a result of the stroke determination, the fill determination module 309 applies the label 201 indicative of whether or not the strokes are the fill to the stroke data (time series information 200) stored in the storage medium 402 by the page save processor 304. Similarly, the fill determination module 309 executes the fill determination process with respect to the query stroke input for the handwriting retrieval to determine the strokes representing the fill.

The query stroke inputting module 307 inputs the query stroke used as a retrieval key in the retrieval process (handwriting retrieval) by the retrieval processor 308 and causes the retrieval processor 308 to execute the retrieval process using the query stroke. The query stroke may include one or more strokes input by the handwriting input operation of the user on the handwriting retrieval screen displayed by the handwriting input application program 103b. Furthermore, the query stroke may include one or more strokes selected from the handwritten page by the handwriting input operation of the user. Furthermore, based on a result of the determination in the fill determination module 309 with respect to the query stroke, the query stroke inputting module 307 designates the fill in the query stroke and causes the retrieval processor 308 to execute the retrieval process.

In order to execute the handwriting retrieval, the retrieval processor 308 includes a stroke retrieval module 310, figure retrieval module 311, stroke dividing module 312, and circumscribing stroke creating module 313.

The stroke retrieval module 310 executes the handwriting retrieval using the query stroke input by the query stroke inputting module 307. When the fill determination module 309 determines the linear strokes, the stroke retrieval module 310 executes the handwriting retrieval with respect to the linear strokes to retrieve a group of strokes corresponding to the query stroke from a handwriting. For example, the stroke retrieval module 310 may retrieve a group of strokes having a feature amount similar to that of the query stroke from a handwriting. The query stroke includes one or more strokes and each of the group of the strokes includes one or more strokes. As described above, the shape, writing direction, and slant of the stroke may be used as the feature amount of each stroke.

To calculate a similarity between the strokes, various methods can be used. For example, the stroke retrieval module 310 calculates the similarity using each stroke as a vector. Here, each stroke may be resampled based on the original stroke data such that the whole strokes have the same number of points (samples).

Furthermore, to normalize a relative positional relationship of each stroke, the vector of each stroke may be converted into a difference vector. That is, when a stroke includes a coordinate data row of (x1, y1), (x2, y2), (x3, y3), the coordinate row may be converted into (0, 0), (x2−x1, y2−y1), (x3−x1, y3−y1). With such a conversion process, every stroke can be regarded as a stroke written from an origin, and thus, the handwriting retrieval can be performed regardless of a position of each stroke in the handwritten page. Note that any conversion method able to normalize the relative positional relationship of each stroke can be used instead of the aforementioned conversion of the coordinate data row.

Furthermore, to normalize the size of each stroke, a vector coordinate of each stroke may be divided by the maximum width or maximum height of each stroke.

A similarity between vectors to be compared (difference vectors) may be calculated as an inner product of the vectors to be compared (difference vectors).

Furthermore, to reduce a load of calculation, a feature amount data (feature amount vector) representing the feature amount of each stroke in the handwriting may be calculated in advance and then stored in the database. Here, the stroke retrieval module 310 calculates the feature amount of the query stroke, uses the feature amount of the query stroke and the feature amount data of each stroke in the database, and retrieves the group of strokes having the feature amount similar to that of the query stroke. Furthermore, to reduce the times of calculation, a process to reduce a dimension of the feature amount vector may be used.

In general, the query stroke is not a single stroke, but in many cases, is a stroke row including a plurality of strokes. In those cases, with respect to each stroke included in a group of query strokes (query stroke row), a similarity between each stroke and a plurality of strokes in the handwriting can be acquired. Then, considering the stroke order of the query stroke row, the stroke row similar to the query stroke row is retrieved from the handwriting. To calculate the similarity between the stroke rows, a Dynamic Programming (DP) matching may be used.

As described above, the similarity is calculated by using strokes as vectors in the handwriting retrieval. When both query stroke and stroke in a handwriting represent the same letter, the similarity calculated by using the strokes as vectors becomes high. In contrast, when both query stroke and stroke in a handwriting represent a filled-in figure such as a circle or quadrilateral painted black, the similarity calculated cannot be high even if they look the same. That is, when fills are written freehand, length and direction of strokes are different in each fill and strokes are sometimes combined together, and therefore, the strokes are not stable. Because of this, even when the strokes represent the same fill, the vectors representing the strokes are different. Thus, the similarity cannot be high.

Therefore, the stroke retrieval module 310 of the present embodiments executes the handwriting retrieval to retrieve the groups of strokes corresponding to the query stroke from the handwriting targeting the strokes which have not been determined to be the surface stroke by the fill determination module 309, that is, the strokes which have been determined to be the linear stroke by the fill determination module 309. When the query stroke (retrieval key) includes the strokes corresponding to the fill, the stroke retrieval module 310 uses the strokes excluding those corresponding to the fill and acquires information concerning the strokes corresponding to the retrieval key. The strokes (surface stroke) which have been determined to be the fill by the fill determination module 309 can be retrieved by the figure retrieval module 311.

The figure retrieval module 311 executes the handwriting retrieval using the query stroke input by the query stroke module 307. The figure retrieval module 311 executes the handwriting retrieval to retrieve the groups of the stroke corresponding to the query stroke targeting the strokes which have been determined to be the surface stroke by the fill determination module 309. The figure retrieval module 311 uses the stroke retrieved by the stroke retrieval module 310 as a vector, and retrieves the fill based on a method different from that is used to calculate the similarity between the strokes.

The stroke dividing module 312 targets a stroke in the handwriting or the query stroke and divides the targeted stroke into a surface stroke representing a fill and a linear stroke which is other than the surface stroke. By dividing each stroke into the surface and linear strokes, the stroke retrieval module 310 and the figure retrieval module 311 execute the retrieval process, respectively.

The circumscribing stroke creating module 313 converts the strokes determined to be the surface stroke by the fill determination module 309, that is, the strokes representing the fill into a circumscribing stroke. For example, the strokes representing a black circle figure may be converted into a stroke circumscribing the black circle figure. Here, the circumscribing stroke is replaced with a circle figure which is not filled in. Thereby, the surface stroke is converted into the linear stroke and thus, the stroke retrieval module 310 can perform the retrieval process.

Now, the working mechanism of the tablet computer 10 in the present embodiment is described.

In the present embodiment, when a query stroke input for the handwriting retrieval includes strokes representing a fill such as a black circle or black quadrilateral, the handwriting input application program 103b targets the fill and performs a process different from that is performed with respect to the portion other than the fill. Thereby, the handwriting retrieval is performed efficiently.

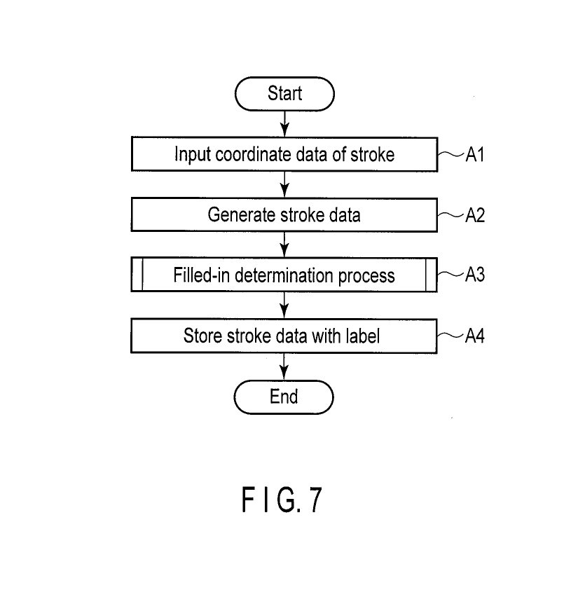

Firstly, an example of how the handwriting is created in the present embodiments is described with reference to the procedures in the flowchart of FIG. 7.

When a user performs the handwriting input operation on the touch screen display 17 with the stylus 100, the stylus trail display processor 301 and the time series information generator 302 read a coordinate data row corresponding to a trail of movement of a point of contact on the touch screen display 17 and input the coordinate data row (Block A1).

The stylus trail display processor 301 displays the trail of the handwritten stroke on the touch screen display 17 (LCD 17A) based on the coordinate data row input from the touch screen display 17. The time series information generator 302 generates a stroke data (time series information) based on the coordinate data row input from the touch screen display 17 (Block A2). For example, the time series information generator 302 performs sampling of input coordinate data at certain time intervals and stores sample points (coordinate data) to convert into vector data. The stroke data to be input may be, for example, a letter, graph, figure, and symbol. As in FIG. 4, the page save processor 304 saves a plurality of stroke data corresponding to a plurality of strokes as a handwriting (handwritten page) in the storage medium 402.

On the other hand, the fill determination module 309 executes the fill determination process with respect to the stroke data (time series information) generated by the time series information generator 302 (Block A3). The fill determination process determines whether or not the strokes are those representing the fill (surface stroke). Here, the fill determination process may be executed each time when the stroke data of a single stroke is generated, or each time when a plurality of stroke data for, for example, a single page are generated. For example, when the save process of the stroke data is performed based on the user's instruction, the fill determination process is executed each time when the data of a page is saved. Hereinafter, the description is presented given that the fill determination process is executed each time when the data of a page is saved.

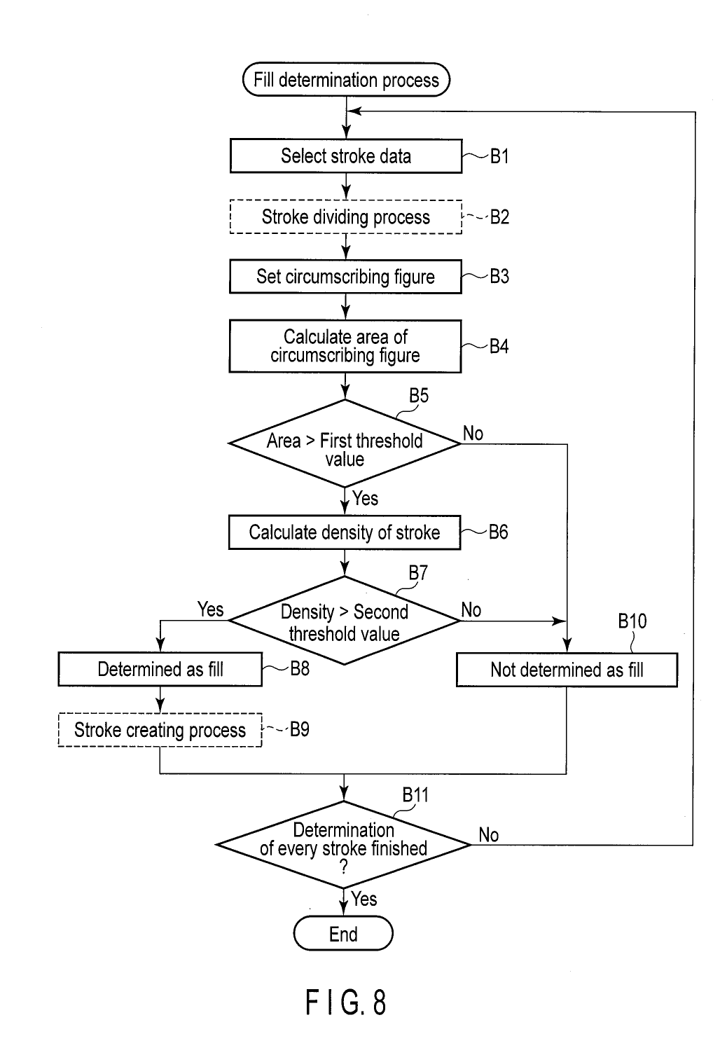

FIG. 8 is a flowchart of an example of the fill determination process of the present embodiments.

Firstly, the fill determination module 309 selects stroke data to be determined from a plurality of stroke data generated by the time series information generator 302 (Block B1). Here, a stroke dividing process indicated as Block B2 is not essential, and thus, details thereof are described later.

Secondly, the fill determination module 309 sets a circumscribing figure of the stroke based on the stroke data (Block B3), and calculates an area of the circumscribing figure (Block B4).

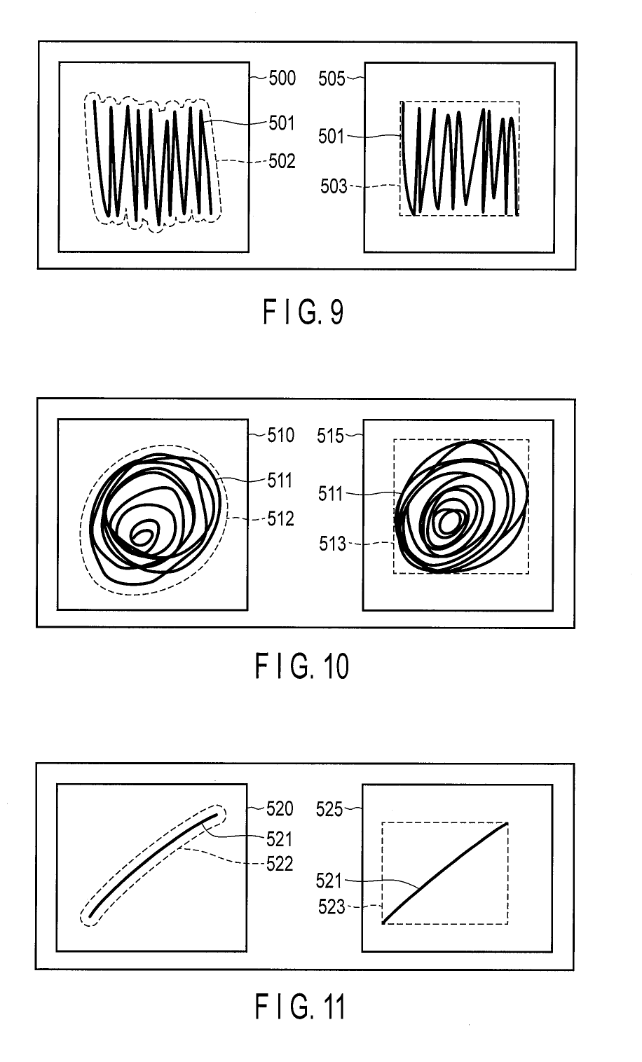

A stroke example 500 in FIG. 9 indicates a stroke 501 input to fill in, for example, a quadrilateral and a circumscribing FIG. 502 set with respect to the stroke 501. The circumscribing FIG. 502 is formed along the circumference of the stroke 501 with a certain distance from the stroke 501. In this example, since the stroke 501 does not form a closed region, the circumscribing figure is set to go along the stroke 501. As a result, the circumscribing FIG. 502 surrounding the stroke 501 is formed as shown in FIG. 9.

A stroke example 510 in FIG. 10 indicates a stroke 511 input to fill in, for example a circle and a circumscribing FIG. 512 set with respect to the stroke 511. In this example, since the stroke 511 forms a closed region, the circumscribing FIG. 512 is set to go along the stroke forming the circumference.

A stroke example 520 in FIG. 11 indicates a stroke 521 representing a general letter or the like and a circumscribing FIG. 522 set with respect to the stroke 521. As can be understood from the stroke example 520, the stroke 521 does not represent a fill and thus, the circumscribing FIG. 522 formed along the stroke 521 is set.

Now, the fill determination module 309 determines whether or not the area of the circumscribing figure set with respect to the stroke is larger than a first threshold value set with respect to a predetermined area. The first threshold value is set to determine whether the stroke has been input to fill in some blank figure or whether the stroke has been input to draw a general letter or figure based on the area of the circumscribing figure set with respect to the stroke.

For example, the strokes 501 and 511 shown in FIGS. 9 and 10, respectively, are the strokes which have been input to fill in some blank figures. Therefore, the areas of the circumscribing FIGS. 502 and 512 corresponding to the strokes 501 and 511 become relatively large. In contrast, the area of the circumscribing FIG. 522 set with respect to the general stroke 521 shown in FIG. 11 becomes relatively smaller as compared to the circumscribing FIGS. 502 and 512.

When the area of the circumscribing figure is not larger than the first threshold value (No in Block B5), the fill determination module 309 determines that the stroke to be determined is not a stroke for filling-in (Block B10).

On the other hand, when the area of the circumscribing figure is larger than the first threshold value (Yes in Block B5), the fill determination module 309 calculates the density of stroke in the circumscribing figure (Block B6). Since the stroke data has been converted into, for example, vector data of sample points, the fill determination module 309 counts the number of the sample points of the stroke to be determined, divides the number by the area of the circumscribing figure, and takes the number of sample points per unit area as the density.

Then, the fill determination module 309 determines whether the density of stroke is larger than a second threshold value with respect to a predetermined stroke density. The second threshold value is set to determine whether the stroke has been input to fill in some blank figure or whether the stroke has been input to draw a general letter or figure based on the area of the stroke in the circumscribing figure.

When the density of stroke is not larger than the second threshold value (No in Block B7), the fill determination module 309 determines that the stroke to be determined is not a stroke for filling-in (Block B10).

On the other hand, when the density of stroke is larger than the second threshold value (Yes in Block B7), the fill determination module 309 determines that the stroke to be determined is a stroke for filling-in (Block B8). Here, a stroke creating process of Block B9 is not essential, and thus, details thereof are described later.

The fill determination module 309 determines whether the determination of the entire strokes has been performed, and if there is a stroke data which has not been determined (No in Block B11), selects the other stroke data as the data to be determined (Block B1) and executes the aforementioned process (Blocks B2 to B11). If the determination of the entire strokes has been performed (Yes in Block B11), the fill determination module 309 terminates the fill determination process.

Note that, in the aforementioned description, the circumscribing FIGS. 502, 512, and 522 are set to the strokes 501, 511, and 521, respectively; however, the circumscribing figures may be replaced with circumscribing rectangles. For example, the fill determination module 309 acquires both maximum value and minimum value of each of x and y coordinates of a coordinate data (sample points) in a stroke data to set such a circumscribing rectangle.

A stroke example 505 in FIG. 9 indicates a circumscribing rectangle 503 set with respect to the stroke 501. Similarly, a stroke example 515 in FIG. 10 indicates a circumscribing rectangle 513 set with respect to the stroke 511, and a stroke example 525 in FIG. 11 indicates a circumscribing rectangle 523 set with respect to the stroke 521.

The circumscribing rectangle 523 in FIG. 11 has an area larger than the first threshold value; however, the stroke density thereof is low. Thus, as with the case of the circumscribing FIG. 522, the circumscribing rectangle 523 is not determined to be a stroke for filling-in.

When the fill determination module 309 terminates the fill determination process, the page save processor 304 adds the label 201 indicative of whether or not the stroke is a fill to the stroke data (time series information 200) and stores the stroke data in the storage memory 402 (Block A4). That is, the page save processor 304 adds a label “surface” indicative of a surface stroke to the stroke which has been determined to be a fill and adds a label “line” indicative of a linear stroke to the stroke which has not been determined to be a fill (cf. FIG. 4).

Furthermore, the page save processor 304 can add a label 202 (label “surface”) in which a plurality of strokes indicative of a fill to the stroke data instead of the label 201 for each stroke. For example, if there is one or more surface strokes in a plurality of strokes and there are coordinate data overlapping one another at least partially in the stroke data, the fill determination module 309 determines that a merged label is applicable to the strokes satisfying these conditions. The page save processor 304 adds the merged label “surface” to the strokes based on a result of the determination by the fill determination module 309.

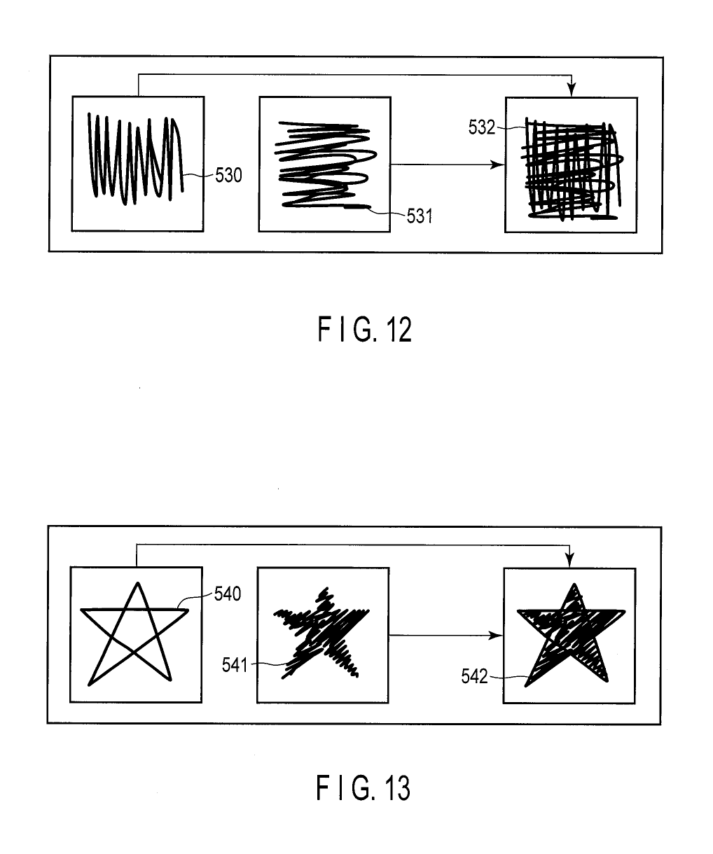

FIG. 12 illustrates an example of how a figure representing a fill is handwritten by a plurality of strokes. In FIG. 12, two strokes 530 and 531 are layered together as a stroke 532 representing a handwritten black rectangular figure. The stroke 530 is a pattern of vertical zigzag stroke and the stroke 531 is a pattern of lateral zigzag stroke.

As described above, the merged label 202 is added to the two strokes 530 and 531 layered together to prepare a filled-in figure or the like.

Note that the merged label 202 may be added not only a case where a plurality of surface strokes layered each other are written but also a case where a linear stroke is handwritten on a surface stroke as a layer.

FIG. 13 illustrates an example of how a FIG. 542 representing a fill is handwritten by a stroke 540 which corresponds to a linear stroke and a plurality of strokes 541 which correspond to a surface stroke. In FIG. 13, an outline of the figure (a star, for example) is written first, and then the strokes are written to fill in the outlined figure.

The fill determination module 309 determines that the strokes 540 and 541 structure the FIG. 542 representing a fill when the coordinate data of these two strokes are within a certain range (including a case where they coincide) and the number of the coordinate data within a certain range is more than a predetermined value. The page save processor 304 adds the merged label “surface” to the strokes 540 and 541. Thus, the linear stroke 540 can be handled as a surface stroke.

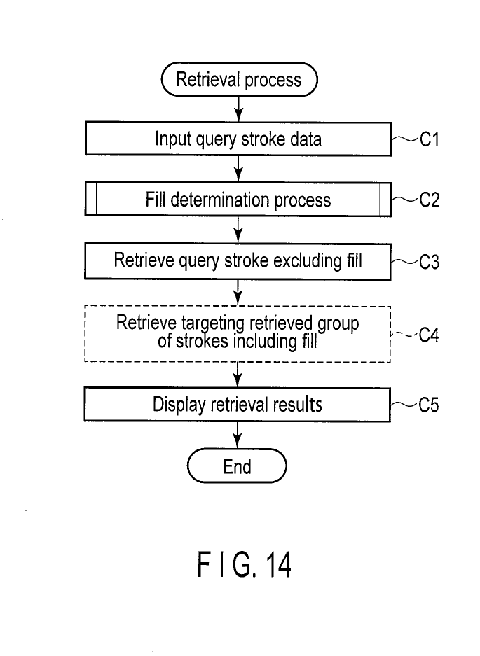

Now, the first retrieval process in the present embodiment is described with reference to the flowchart of FIG. 14.

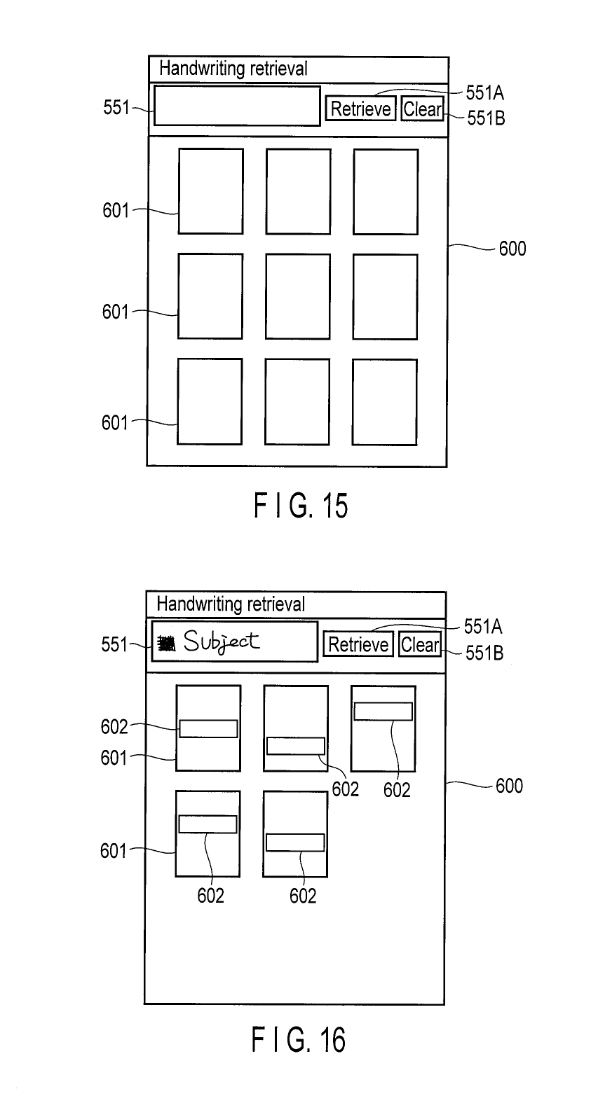

FIG. 15 illustrates an example of a handwriting retrieval screen 600 displayed to a user by the handwriting input application program 103b.

The handwriting retrieval screen 600 displays a retrieval key input region 551, retrieval button 551A, and clear button 551B. The retrieval key input region 551 is a region to receive an input of handwriting of a stroke (query stroke) to be a retrieval key. The retrieval button 551A is a button to instruct the execution of the handwriting retrieval process. The clear button 551B is to instruct the cancel (clear) of the letter or figure handwritten on the retrieval key input region 551.

The handwriting retrieval screen 600 may further display a plurality of handwritten page thumbnails 601. In the example shown in FIG. 15, nine handwritten page thumbnails 601 corresponding to nine handwritings.

Here, the description is presented given that a gesture (a tap gesture, for example) is detected on the retrieval button 551A while the strokes representing a filled-in figure and strokes representing “Subject” are input on the retrieval key input region 551 as a query stroke. The handwriting input application program 103b starts the handwriting retrieval to retrieve a group of strokes whose feature amount is similar to the query stroke from, for example, the handwritings corresponding to nine handwritten page thumbnails 601.

When the stroke data of the query stroke is generated by the time series information generator 302 (Block C1), the fill determination module 309 executes a filling-in process with respect to each stroke in the query stroke and divides the strokes into surface strokes representing a fill and other linear strokes (Block C2). The filling-in process is not described here in details since it is performed in the aforementioned manner (cf. the flowchart of FIG. 8).

The query stroke inputting module 307 inputs the query stroke data to the retrieval processor 308 and causes the retrieval processor 308 to execute the retrieval process using the query stroke data as the retrieval key. The query stroke inputting module 307 designates the fill in the query stroke which has been determined by the fill determination module 309.

The stroke retrieval module 310 of the retrieval processor 308 retrieves the group of strokes corresponding to the strokes excluding the fill (surface strokes) in the query stroke (linear strokes) from the target handwritings, in other words, the stroke retrieval module 310 retrieves the group of strokes having a similarity to the feature amount of the strokes excluding those corresponding to the fill, which is than a predetermined determination reference, from the target handwritings (Block C3). To retrieve desired strokes, for example, a similarity between vectors of each stroke is acquired and only the strokes matching with the query is retrieved by the DP matching for the query of a plurality of strokes. Furthermore, the retrieval processor 308 displays the groups of strokes retrieved from the handwriting in the handwriting retrieval screen 600 (Block C5). Note that Block C4 in FIG. 14 is described later.

As a result of the retrieval, the handwriting retrieval screen 600 shown in FIG. 16 displays the handwritten page thumbnails of the handwriting including the query stroke whose similarity is higher than the determination reference. FIG. 16 indicates a case where the groups of strokes corresponding to the query stroke are retrieved from five out of the nine handwritten pages. In the five handwritten page thumbnails, the groups of strokes corresponding to the query stroke are highlighted. To highlight the groups, rectangular frames 602 may be added to the retrieved group, the display color of the retrieved groups may be changed (into red, for example) from that of the other strokes, and display mode of the retrieved groups may be converted in reverse display.

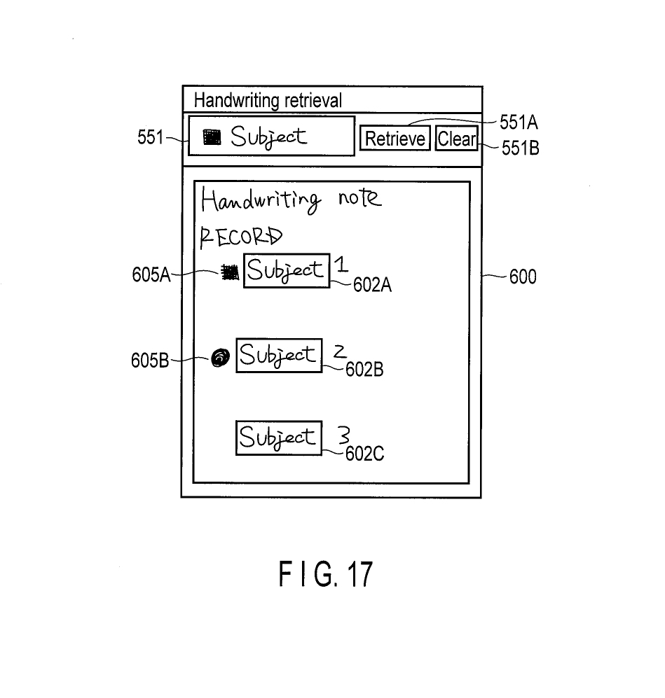

Furthermore, when one of the handwritten page thumbnails is selected by the user from the handwriting retrieval screen 600, the retrieval processor 308 displays the handwritten page corresponding to the selected handwritten page thumbnail 601 in a regular size on the handwriting retrieval screen 600 as shown in FIG. 17. In the example of FIG. 17, groups of strokes 602A, 602B, and 602C are retrieved as a result of the retrieval using the query stroke representing the character string of “Subject” input in the retrieval key input region 551. Strokes 605A and 605B representing fills are added to the left side of the groups of strokes 602A and 602B, respectively; however, the fills are not used in the retrieval. Therefore, the groups of strokes 602A and 602B corresponding to the query stroke which represents the character string “Subject” can be retrieved accurately not being influenced by the stroke 605A or 605B. Furthermore, a stroke representing a fill generally has the length longer than that of a stroke representing a character string, and therefore, time to calculate a similarity between strokes for filling-in is relatively longer than time to calculate a similarity between strokes for character. However, the strokes for filling-in are not used in the retrieval (calculation of similarity), and thus, the speed of the retrieval process can be advanced.

Note that the fill in the query stroke (surface stroke) is excluded from the aforementioned retrieval process; however, the fill (surface stroke) may be used therein to narrow down the groups of strokes in the retrieval result.

That is, the stroke retrieval module 310 targets the groups of strokes retrieved in Block C3 shown in FIG. 14 to retrieve the groups of strokes including the strokes for filling-in (Block C4).

For example, as shown in FIG. 17, the retrieval based on the query stroke representing the character string “Subject” input in the retrieval key input region 551 results in the groups of strokes 602A, 602B, and 602C. In the retrieval key input region 551, the strokes representing the character string “Subject” used in the retrieval are written following the strokes representing the fill, and thus, the stroke retrieval module 310 selects the groups of strokes in which the fill is drawn in front thereof from the groups of strokes 602A, 602B, and 602C. In the example of FIG. 17, the fills 605A and 605B are in front of the groups of strokes 602A and 602B, and therefore, the groups of strokes 602A and 602B are selected as the retrieval result. The group of stroke 602C is not selected since it corresponds to only the strokes in the query row but not the fill.

As can be understood from the above, the retrieval process can be executed with better accuracy by using the fill in the query stroke. In the present embodiment, the strokes representing the fill are not recognized as a character string or figure such as a black quadrilateral or black circle, and thus, an additional recognition process is not required and the retrieval process using a fill can be operable.

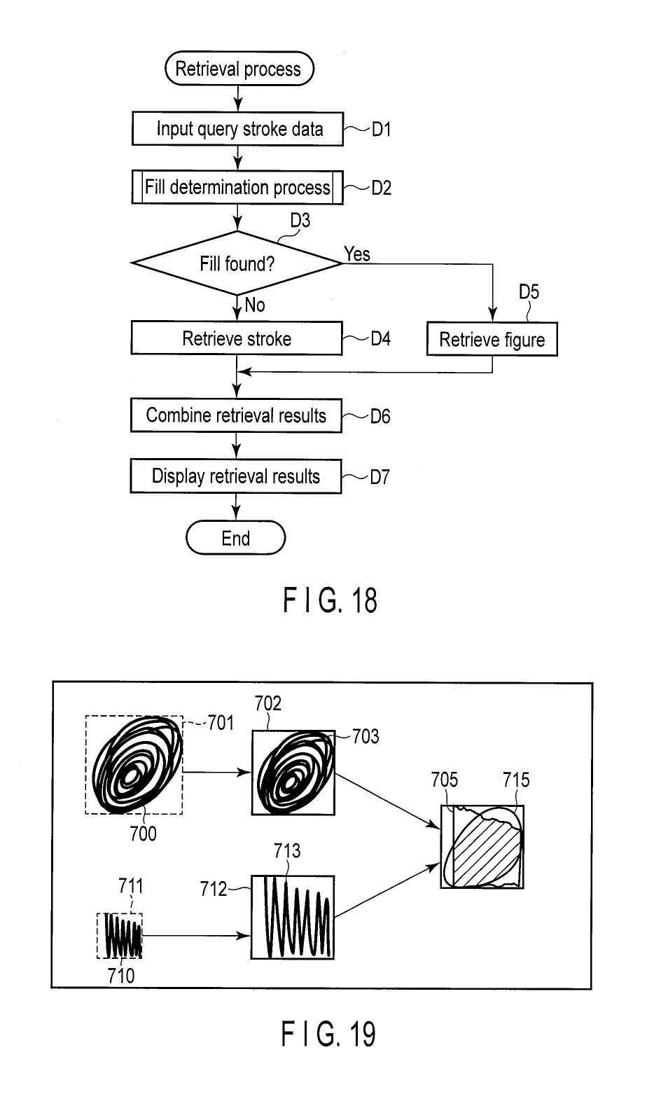

Now, a second retrieval process in the present embodiment is described with reference to the flowchart shown in FIG. 18.

The first retrieval process does not calculate a similarity between a fill in a query stroke and a fill in a handwriting. The second retrieval process calculates an evaluation value indicative of a similarity between a fill in a query stroke and a fill in a handwriting and reflects the evaluation value on the retrieval process.

Blocks D1 and D2 shown in FIG. 18 are not described in detail here since they are performed as Blocks C1 and C2 shown in FIG. 14.

The stroke retrieval module 310 executes the stroke retrieval of a stroke which is not determined to be a fill in a query stroke (linear stroke) in the manner similar to the first retrieval process. That is, the stroke retrieval is performed targeting the strokes to which a label indicative of a linear stroke such as a handwriting or the like (Block D4).

On the other hand, regarding a stroke which is determined to be a fill in a query stroke (surface stroke), the figure retrieval module 311 figures the stroke and calculates the evaluation value indicative of a similarity between the figured stroke and strokes in the handwriting (Block D5). Hereinafter, the process of deriving the evaluation value is referred to as figure retrieval.

FIG. 19 illustrates how the figure retrieval is performed. FIG. 19 indicates a surface stroke 700 in a query stroke and a surface stroke 710 in a handwriting. The figure retrieval module 311 sets circumscribing squares 701 and 711 to the surface stroke 700 in the query stroke and the surface stroke 710 in the handwriting, which is a target for retrieval, respectively. The figure retrieval module 311 then enlarges/reduces the surface strokes 700 and 710 so that the circumscribing squares 701 and 711 can have the same size. In the example of FIG. 19, the circumscribing square 701 is reduced to be a circumscribing square 702 and the circumscribing square 711 is enlarged to be a circumscribing square 712 whose size is the same as that of the circumscribing square 702.

Then, the figure retrieval module 311 calculates a circumscribing figure of each of the surface stroke 703 which is the reduced surface stroke 700 and the surface stroke 713 which is the enlarged surface stroke 710. The circumscribing figures are fully painted out and a similarity between the painted-out figures is calculated. For example, the figure retrieval module 311 layers the figures to be compared one another and evaluates a size ratio of the overlapping area as a score.

FIG. 19 indicates a state where a FIG. 715 (query figure A) corresponding to the circumscribing figure of the surface stroke 703 and a FIG. 705 (retrieval target figure B) corresponding to the circumscribing figure of the surface stroke 713 overlap with each other. The figure retrieval module 311 acquires the score S based on the formula of S=2(Sab)/(Sa+Sb), where the area of the query figure A is Sa, the area of the retrieval target figure B is Sb, and the overlapping area when the query figure A and retrieval target figure B are layered together is Sab. The similarity between the query figure A and the retrieval target figure B is evaluated higher when the score S becomes larger. The score S shows the agreement of the retrieval target figure B with the query figure A used in the retrieval. If there are a plurality of fills in the query strokes, the figure retrieval module 311 repeats the aforementioned process with respect to each fill.

After the query strokes have been divided into the fill and the other part, and both stroke retrieval (Block D4) and figure retrieval (Block D5) have been completed, the stroke retrieval module 310 merges the retrieval results together (Block D6). For example, the stroke retrieval module 310 converts the evaluation value (score S) calculated in the figure retrieval into the similarity calculated in the stroke retrieval and performs the DP matching in accordance with the order of strokes as in the manner similar to the stroke retrieval. Therefore, the storage medium 402 can retrieve the strokes matching the query strokes in the handwriting.

Here, the similarity between the query stroke (linear stroke) and the stroke in the handwriting can be derived in a rage of (−1 to +1), for example. If the strokes have the same shape and same stroke direction, the similarity is derived as +1, and if the strokes have the same shape but opposite stroke directions, the similarity is derived as −1. In the figure retrieval, the score S is derived in a range of 0 to +1, for example. Here, the score S of the figure retrieval is converted into the similarity 0 to +1 of the stroke retrieval.

The retrieval processor 308 displays the groups of strokes retrieved from the handwriting on the handwriting retrieval screen 600 in the manner similar to the aforementioned first retrieval process (Block D7).

As can be understood from the above, with the second retrieval process, the retrieval can be performed not only when strokes including a fill are input as a query stroke but also when only strokes representing a fill are input. The figure which is a mixture of linear and surface strokes can be subjected to the retrieval process. For example, a mark or figure such as a fermata mark, G-clef, and eighth note (quaver) is a combination of lines and dots, and even if a dot is represented by a handwritten black circle, the second retrieval process can be performed.

Now, example applications for the fill determination process are described.

Firstly, the stroke dividing process of Block B2 in FIG. 8 is explained.

In the aforementioned fill determination process, the determination is done on a stroke-by-stroke basis. In contrast, when a single stroke includes a fill and the other part, the stroke is divided into the fill and a substroke which represents the other part.

The stroke dividing module 312 generates a substroke based on stroke data of a stroke input in creating a handwriting and a query stroke input for a retrieval process.

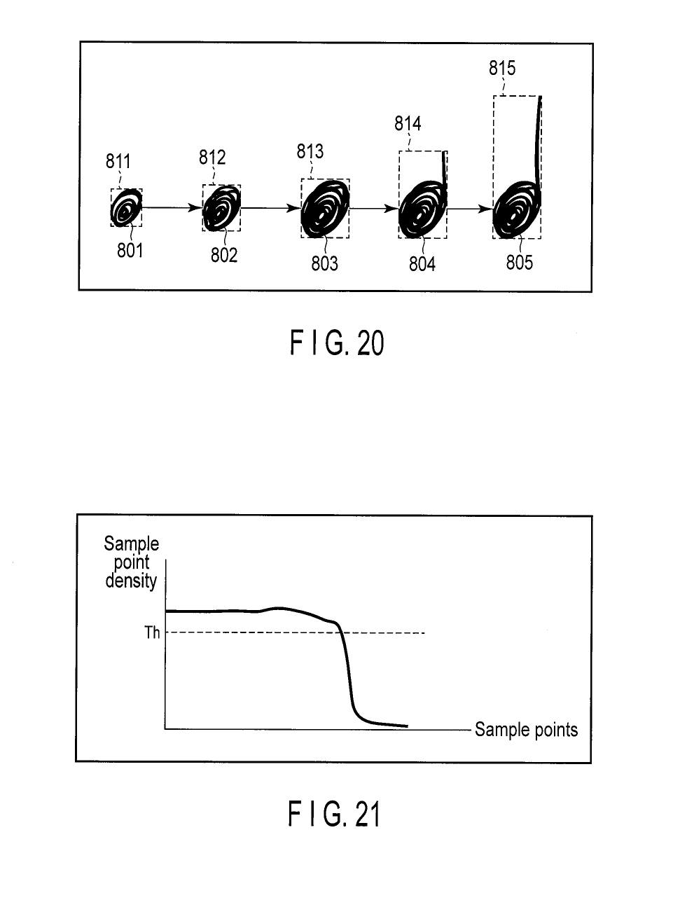

FIG. 20 illustrates how a single stroke is written by handwriting. FIG. 20 indicates an example of handwriting a stroke representing a quarter note (crotchet), and therein, a black circle is input first and a line is input second.

The stroke dividing module 312 sets circumscribing figures (circumscribing rectangles may be used for simpler calculation) targeting a first sample point to nth sample point which is relatively large, and acquires a density of sample point (a density of stroke) based on the number of sample points of the strokes in the circumscribing figures and the areas of the circumscribing areas. When the density is larger than a threshold value Th, the number of n (the number of sample points) is increased until the density is reduced suitably. The stroke dividing module 312 divides the stroke at nth sample point where the density of the sample points is or less than the threshold value Th (or the density becomes the largest) and generates a substroke.

For example, FIG. 20 indicates an example where the black circle is handwritten as depicted in strokes 801, 802, and 803. Circumscribing rectangles 811, 812, and 813 are set to the strokes 801, 802, and 803, respectively. The circumscribing rectangles 811, 812, and 813 are set to the stroke representing the fill and thus, the density of sample points becomes high. Then, when a rod is handwritten as depicted in a stroke 814, the area of the circumscribing rectangle 814 corresponding to the stroke 814 becomes large and the density of sample points becomes low. When a stroke 805 representing a quarter note is input eventually, a circumscribing rectangle 815 is set and the density of sample points becomes lowest.

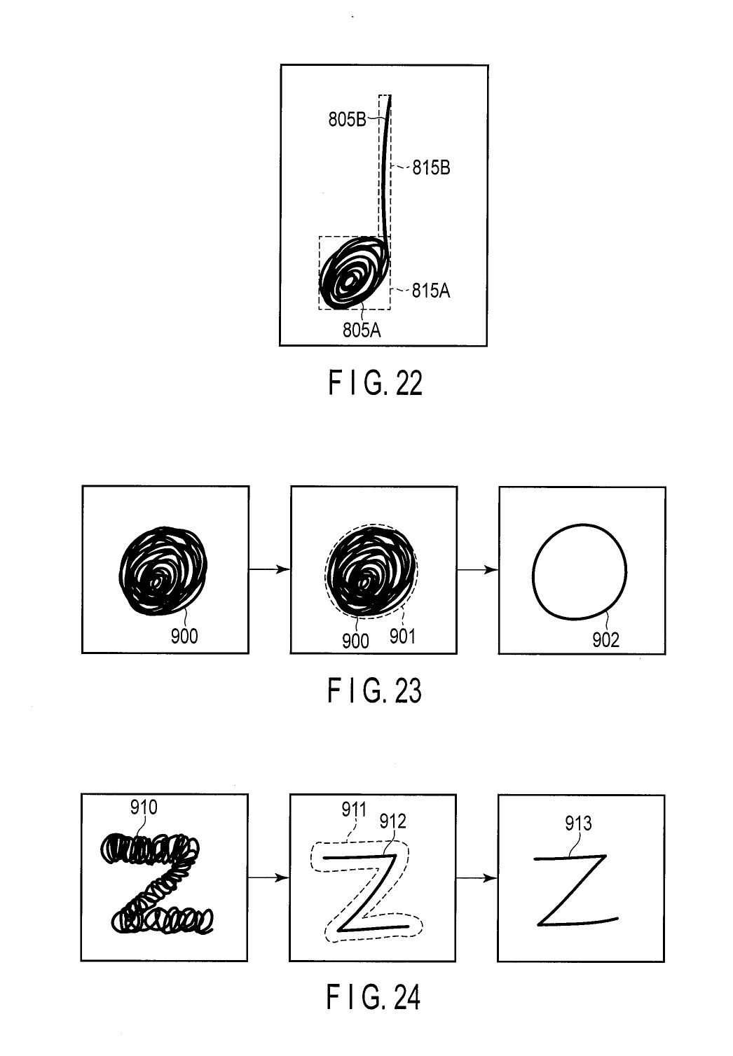

FIG. 21 is a graph indicating a relationship between the number of sample points in a handwritten stroke and the density of sample points. As shown in FIG. 21, the density of sample points decreases significantly when the vertical line of the quarter note is input. The stroke dividing module 312 divides the single stroke 805 shown in FIG. 20 into two substrokes 805A and 805B as shown in FIG. 22.

Furthermore, to correspond to a case where a line stroke is written first and a black circle is written second, a single stroke may be divided by setting circumscribing figures to the last sample point to the first sample point of the stroke data in sequence to check a change in the density of sample points.

As can be understood from the above, a single stroke can be divided into a stroke for filling (surface stroke) and a stroke for the other part (linear stroke) by the stroke dividing module 312. By handling the substroke as with the other stroke, the aforementioned fill determination process, first retrieval process, and second retrieval process are all executable even when a single stroke includes a fill and the other part.

Now, the stroke creating process shown of Block B9 in FIG. 8 is explained.

In the stroke creating process, a surface stroke determined to be a fill is replaced with a linear stroke. The circumscribing stroke creating module 313 sets a circumscribing figure with respect to the surface stroke determined to be a fill and renders the circumscribing figure as a new linear stroke.

FIG. 23 illustrates an example of a surface stroke 900 which has been determined to be a fill. The circumscribing stroke creating module 313 sets a circumscribing FIG. 901 with respect to the surface stroke 900 and converts the line representing the circumscribing FIG. 901 into a linear stroke 902. The linear stroke 902 is handled the same as the other linear strokes.

As can be understood from the above, by replacing a stroke representing a fill with a stroke representing a circumscribing figure, a stroke representing a filled-in black circle is replaced with a stroke representing a white circle surrounded by a black line and a stroke representing a filled-in black quadrilateral is replaced with a stroke representing a white quadrilateral surrounded by a black line, for example. Thus, when a stroke representing a white quadrilateral surrounded by a black line is input as a query stroke, a filled-in black quadrilateral input when creating a handwriting can be retrieved. Furthermore, by replacing a surface stroke with a linear stroke, a figure retrieval is not required in the second retrieval process.

Here, in the example of FIG. 23, the surface stroke 900 is replaced with the stroke corresponding to a circumscribing figure, but it may be replaced with a linear stroke by narrowing the figure corresponding to the circumscribing figure.

FIG. 24 illustrates an example of a surface stroke 910 which has been determined to be a fill. The circumscribing stroke creating module 313 sets a circumscribing FIG. 911 with respect to the surface stroke 910 and generates a line segment 912 by narrowing the circumscribing FIG. 911. The circumscribing stroke creating module 313 converts the line segment 912 into a linear stroke 913. By narrowing a circumscribing figure, a surface stroke can be replaced with a linear stroke.

Here, each process with respect to a handwriting of the present embodiments can be executed by a computer program. Thus, when a computer program to execute each process of the present embodiments is installed in a computer through a computer-readable storage medium storing such a program and executed, the same advantage obtained is easily achievable.

Furthermore, as mentioned above, the handwriting retrieval process of the present embodiments may be achieved by a local system in the tablet computer 10, or may be achieved by a server system structured by one or more servers. Otherwise, the handwriting retrieval process may be achieved in such a system in which a part of the handwriting retrieval process is executed by the tablet computer 10 and the other part is executed by one or more servers.

Moreover, the present embodiments have been explained given that a tablet computer is used; however, the handwriting retrieval process may be applicable to an ordinary desktop personal computer. Here, an input device to receive a handwriting such as a tablet and the like is connected to the desktop personal computer to achieve the handwriting retrieval process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
receiving a first stroke corresponding to a retrieval key for retrieving a handwritten stroke stored in a memory of an electronic apparatus;
acquiring, if the first stroke comprises a second stroke for filling an area and a third stroke not for filling an area, first information relating to at least one stroke corresponding to the retrieval key by using the third stroke, wherein the second stroke corresponds to one part of the first stroke, and the third stroke corresponds to another part of the first stroke; and
storing the first information in the memory.

2. The method of claim 1, further comprising performing a determination of the second stroke based on the area and a density of the second stroke within the area.

3. The method of claim 1, further comprising retrieving a fourth stroke comprising the third stroke in the handwriting and a second fill based on the area.

4. The method of claim 1, further comprising retrieving the third stroke from the handwriting based on a first retrieval using the first stroke excluding the second stroke and a second retrieval using the second stroke.

5. The method of claim 4, further comprising performing the second retrieval by figuring the second stroke.

6. The method of claim 1, further comprising dividing the first stroke into a first substroke which represents the area and a second substroke which does not represent the area.

7. The method of claim 1, further comprising replacing the second stroke which represents the area with a fourth stroke which does not represent the area.

8. An electronic apparatus comprising:
an input module configured to receive a first stroke corresponding to a retrieval key for retrieving a handwritten stroke stored in a memory of an electronic apparatus; and
an acquisition controller configured to, if the first stroke comprises a second stroke for filling an area and a third stroke not for filling an area, acquire first information relating to at least one stroke corresponding to the retrieval key by using the third stroke, wherein the second stroke corresponds to one part of the first stroke, the third stroke corresponds to another part of the first stroke, and the first information is stored in the memory.

9. The electronic apparatus of claim 8, wherein the acquisition controller comprises:
a first retrieval controller based on the first stroke excluding the second stroke; and
a second retrieval controller based on the second stroke, and
the acquisition controller retrieves the third stroke from the handwriting based on retrieval results of the first and second retrieval controllers.

10. The electronic apparatus of claim 8, further comprising a dividing controller configured to divide the first stroke into a first substroke which represents the area and a second substroke which does not represent the area.

11. The electronic apparatus of claim 8, further comprising a conversion controller configured to convert the second stroke which represents the area into a fourth stroke which does not represent the area.

12. A non-transitory computer-readable storage medium storing computer-executable instructions that, when executed, functionalizes a computer as:
an input module configured to receive a first stroke corresponding to a retrieval key for retrieving a handwritten stroke stored in a memory of an electronic apparatus; and
an acquisition controller configured to, if the first stroke comprises a second stroke for filling an area and a third stroke not for filling an area, acquire first information relating to at least one stroke corresponding to the retrieval key by using the third stroke, wherein the second stroke corresponds to one part of the first stroke, the third stroke corresponds to another part of the first stroke, and the first information is stored in the memory.

13. The storage medium of claim 12, further functionalizing the computer as:
a first retrieval controller based on the first stroke excluding the second stroke; and
a second retrieval controller based on the second stroke, and wherein
the storage medium is for retrieving the third stroke from the handwriting based on retrieval results of the first and second retrieval controllers.

14. The storage medium of claim 12, further functionalizing the computer as:
a dividing controller configured to divide the first stroke into a first substroke which represents the area and a second substroke which does not represent the area.

15. The storage medium of claim 12, further functionalizing the computer as:
a conversion controller configured to convert the second stroke which represents the area into a fourth stroke which does not represent the area.
